(19) United States
(12) Patent Application Publication
(10) Pub. No.: US 2026/0095806 A1
(43) Pub. Date: Apr. 2, 2026

(54) DATA STREAM CONTROL FOR EXTENDED REALITY COMMUNICATIONS

(71) Applicant: QUALCOMM Incorporated, San Diego, CA (US)

(72) Inventors: Hyun Yong LEE, San Diego, CA (US); Prashanth Haridas HANDE, San Diego, CA (US); Peerapol TINNAKORNSRISUPHAP, San Diego, CA (US); Belal Salama Amin KORANY, San Diego, CA (US); Prasada Veera Reddy KADIRI, San Diego, CA (US); Mickaël MONDET, Louannec (FR); Diana MAAMARI, San Diego, CA (US); Linhai HE, San Diego, CA (US)

(21) Appl. No.: 19/298,079

(22) Filed: Aug. 12, 2025

Related U.S. Application Data
(60) Provisional application No. 63/701,937, filed on Oct. 1, 2024.

(51) Int. Cl. H04W 28/02

(52) U.S. Cl. CPC H04W 28/0257

(57) ABSTRACT

Various aspects of the present disclosure generally relate to wireless communication. In some aspects, a user equipment (UE) may receive a configuration message conveying recommended bit rate (RBR) information, wherein the configuration message includes a type indicator that indicates whether the RBR information is to be interpreted as being an enhanced type of RBR information or a non-enhanced type of RBR information. The UE may communicate extended reality (XR) traffic in accordance with a data stream configuration of the RBR information and based on the type indicator indicating the RBR information is to be interpreted as the enhanced type of RBR information. Numerous other aspects are described.

### CROSS-REFERENCE TO REFERENCE TO RELATED APPLICATION

This Patent Application claims priority to U.S. Provisional Patent Application No. 63/701,937, filed on Oct. 1, 2024, entitled “DATA STREAM CONTROL FOR EXTENDED REALITY COMMUNICATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with data stream control for extended reality (XR) communications.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Extended reality (XR) technologies, which include virtual reality (VR), augmented reality (AR), or mixed reality (MR), among other examples, are can be integrated into wireless communication networks to deliver immersive multimedia experiences. XR applications that use XR technologies may necessitate the transmission of high-quality, low-latency audio or video data streams, making efficient rate control and bandwidth management a consideration for user experiences. In wireless communication systems, devices can recommend and manage bit rates for data transmission between user equipment (UEs) and network nodes. Bit rate recommendation protocols, including the use of medium access control (MAC) control element (MAC-CE) commands, can be used for dynamic adjustment of network resources to support XR applications.

### SUMMARY

Some aspects described herein relate to a method of wireless communication performed by a user equipment (UE). The method may include receiving a configuration message conveying recommended bit rate (RBR) information, wherein the configuration message includes a type indicator that indicates whether the RBR information is to be interpreted as being an enhanced type of RBR information or a non-enhanced type of RBR information. The method may include communicating extended reality (XR) traffic in accordance with a data stream configuration of the RBR information and based on the type indicator indicating the RBR information is to be interpreted as the enhanced type of RBR information.

Some aspects described herein relate to a method of wireless communication performed by a network node. The method may include transmitting a configuration message conveying RBR information, wherein the configuration message includes a type indicator that indicates whether the RBR information is to be interpreted as being an enhanced type of RBR information or a non-enhanced type of RBR information. The method may include communicating XR traffic in accordance with a data stream configuration of the RBR information and based on the type indicator indicating the RBR information is to be interpreted as the enhanced type of RBR information.

Some aspects described herein relate to a non-transitory computer-readable medium that stores a set of instructions for wireless communication by a UE. The set of instructions, when executed by one or more processors of the UE, may cause the UE to receive a configuration message conveying RBR information, wherein the configuration message includes a type indicator that indicates whether the RBR information is to be interpreted as being an enhanced type of RBR information or a non-enhanced type of RBR information. The set of instructions, when executed by one or more processors of the UE, may cause the UE to communicate XR traffic in accordance with a data stream configuration of the RBR information and based on the type indicator indicating the RBR information is to be interpreted as the enhanced type of RBR information.

Some aspects described herein relate to a non-transitory computer-readable medium that stores a set of instructions for wireless communication by a network node. The set of instructions, when executed by one or more processors of the network node, may cause the network node to transmit a configuration message conveying RBR information, wherein the configuration message includes a type indicator that indicates whether the RBR information is to be interpreted as being an enhanced type of RBR information or a non-enhanced type of RBR information. The set of instructions, when executed by one or more processors of the network node, may cause the network node to communicate XR traffic in accordance with a data stream configuration of the RBR information and based on the type indicator indicating the RBR information is to be interpreted as the enhanced type of RBR information.

Some aspects described herein relate to a UE for wireless communication. The user equipment may include one or more memories and one or more processors coupled to the one or more memories. The one or more processors may be configured to receive a configuration message conveying RBR information, wherein the configuration message includes a type indicator that indicates whether the RBR information is to be interpreted as being an enhanced type of RBR information or a non-enhanced type of RBR information. The one or more processors may be configured to communicate XR traffic in accordance with a data stream configuration of the RBR information and based on the type indicator indicating the RBR information is to be interpreted as the enhanced type of RBR information.

Some aspects described herein relate to a network node for wireless communication. The network node may include one or more memories and one or more processors coupled to the one or more memories. The one or more processors may be configured to transmit a configuration message conveying RBR information, wherein the configuration message includes a type indicator that indicates whether the RBR information is to be interpreted as being an enhanced type of RBR information or a non-enhanced type of RBR information. The one or more processors may be configured to communicate XR traffic in accordance with a data stream configuration of the RBR information and based on the type indicator indicating the RBR information is to be interpreted as the enhanced type of RBR information.

Some aspects described herein relate to an apparatus for wireless communication. The apparatus may include means for receiving a configuration message conveying RBR information, wherein the configuration message includes a type indicator that indicates whether the RBR information is to be interpreted as being an enhanced type of RBR information or a non-enhanced type of RBR information. The apparatus may include means for communicating XR traffic in accordance with a data stream configuration of the RBR information and based on the type indicator indicating the RBR information is to be interpreted as the enhanced type of RBR information.

Some aspects described herein relate to an apparatus for wireless communication. The apparatus may include means for transmitting a configuration message conveying RBR information, wherein the configuration message includes a type indicator that indicates whether the RBR information is to be interpreted as being an enhanced type of RBR information or a non-enhanced type of RBR information. The apparatus may include means for communicating XR traffic in accordance with a data stream configuration of the RBR information and based on the type indicator indicating the RBR information is to be interpreted as the enhanced type of RBR information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example associated with data stream control for extended reality (XR) communications, in accordance with the present disclosure.

FIG. 4 is a diagram illustrating an example process performed, for example, at a user equipment (UE) or an apparatus of a UE, in accordance with the present disclosure.

FIG. 5 is a diagram illustrating an example process performed, for example, at a network node or an apparatus of a network node, in accordance with the present disclosure.

FIG. 6 is a diagram of an example apparatus for wireless communication, in accordance with the present disclosure.

FIG. 7 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Extended reality (XR) technologies may include augmented reality (AR), virtual reality (VR), or mixed reality (MR), among other examples. For example, when providing an XR service, a user equipment (UE) may provide rendered data via a display (such as a screen), a set of VR goggles, a heads-up display, or another type of display. The XR functionalities may be supported by an application server. The application server may host an application, such as a gaming application, a video streaming application, an XR, VR, or AR application, and/or another type of application for which communication flows of streaming data are provided between a UE and the application server. A UE, which is providing an XR service, may transmit data to and/or receive data from, a network node (and/or an application server associated therewith). For example, the network node may transmit data to a UE to render onto a display. In some examples, the UE may transmit video data and/or location data to the network node for processing. For example, the UE may offload some video processing to the network node and may receive video data that has been processed by the network node for display.

Adaptive rate control (ARC) is a technique to adjust a data rate of a data stream. For example, a UE and/or a network node may adjust a data rate with which multimedia data is being communicated based on a dynamic channel condition of a link between the UE and the network node. ARC can be used to achieve real-time and low latency requirements of some XR services. Explicit congestion notification (ECN) is a feature used in low latency, low loss, and scalable (L4S) network services, such as for XR service. The L4S network service may mark a packet with a congestion experienced (CE) marking codepoint in an Internet Protocol (IP) header when a queue delay satisfies a threshold. A receiving application may pass CE markings back to a sending application (e.g., using transport protocol feedback) to cause the sending application to adjust a sending bitrate based on the feedback. Additional details regarding ECN are described in Internet Engineering Task Force (IETF) Request for Comments (RFC) 9331.

A radio access network (RAN) may adopt ECN/L4S marking to adjust a data rate for XR traffic. However, one or more intermediate transport network routers may remove ECN/L4S marking from a packet header, which may prevent effective data rate adjustment for XR traffic. This may be a particular issue for uplink traffic (e.g., multimedia rendering offloading) associated with an XR service. Accordingly, an explicit indication of a recommended bit rate may be provided from a RAN to a UE. Explicit indication of a recommended bit rate may provide for ARC in networks that have intermediate transport network routers and may reduce a delay associated with ARC based on ECN/L4S marking. However, XR traffic may have characteristics for which a recommended bit rate (RBR) indicator is poorly suited.

Various aspects relate generally to data stream control for XR traffic. Some aspects more specifically relate to a type of RBR indicator that is specified for parameters of XR traffic. In some aspects, a UE may receive an RBR indicator that is associated with a particular format or type indicator and may interpret the RBR indicator as an XR traffic type of RBR indicator. The XR traffic type of RBR indicator may differ from another (e.g., legacy) type of RBR indicator with respect to one or more parameters, such as a bit rate granularity, an RBR update policy, an averaging window, a video sequence pattern, or support for a maximum bit rate.

Particular aspects of the subject matter described in this disclosure can be implemented to realize one or more of the following potential advantages. In some examples, the described techniques can be used to interpret an RBR indicator as an XR traffic type of RBR indicator. Based on adjusting one or more configurations (e.g., an ARC configuration) based on the XR traffic type of RBR indicator, the described techniques can be used to improve XR service performance, such as by improving throughput, reducing latency, improving reliability, or reducing loss, among other examples.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

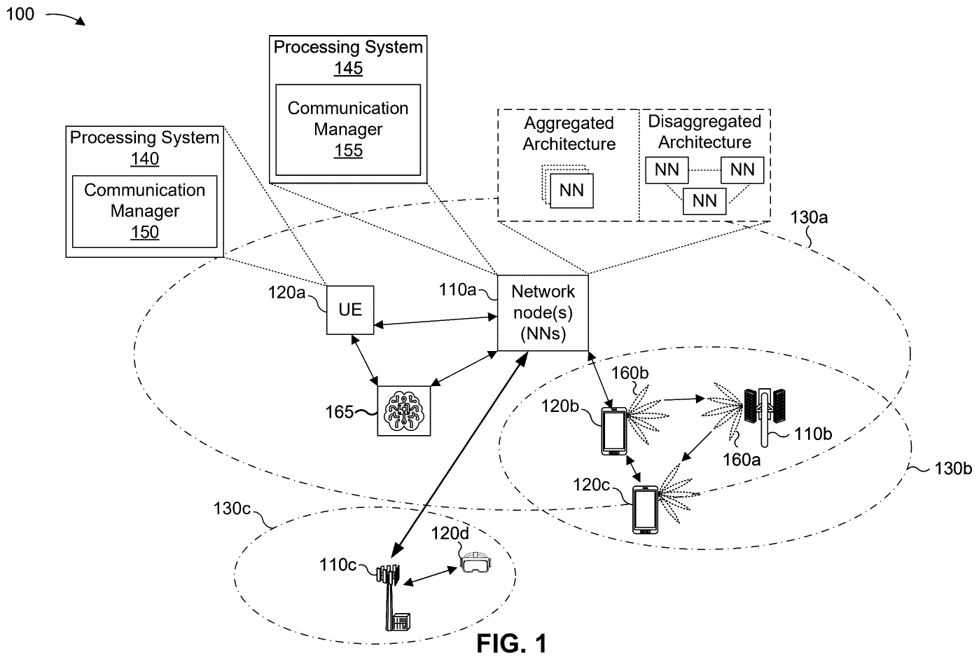

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, and a UE 120d, which may be an XR device. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

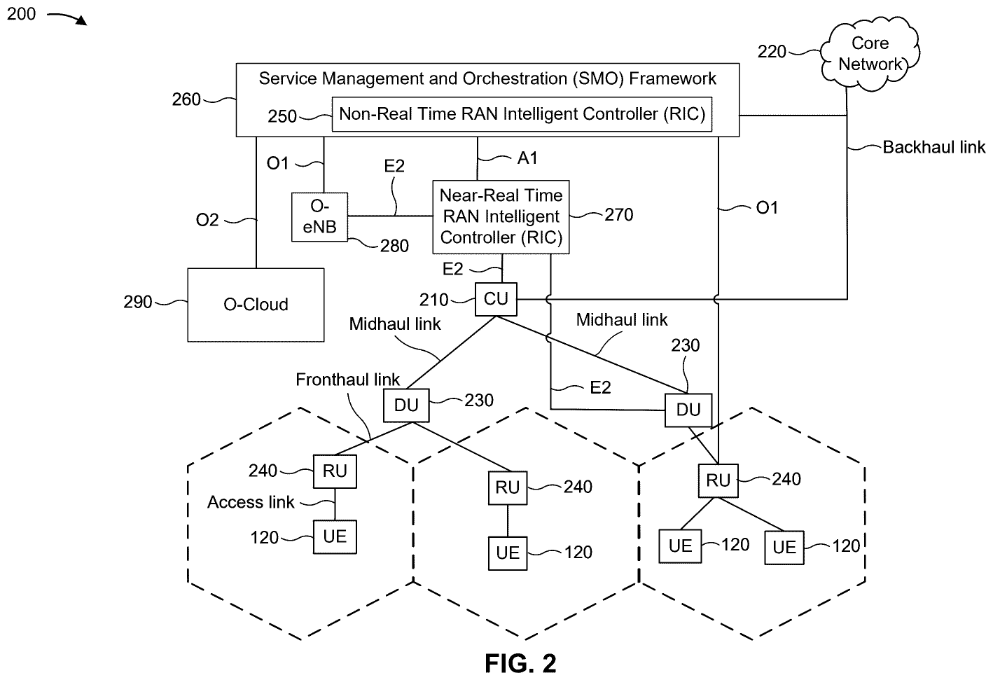

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Some UEs 120, such as the UE 120d, may support one or more XR functionalities. For example, the UE 120d may be an XR device or may be associated with an XR device (for example, the UE 120d may be connected to the XR device, such as via a wired (for example, universal serial bus (USB), or serial advanced technology attachment (SATA)) connection and/or a wireless (for example, Bluetooth, Wi-Fi, 5G) connection). XR functionalities may include augmented reality (AR), virtual reality (VR), or mixed reality (MR), among other examples. For example, when providing an XR service, the UE 120d may provide rendered data via a display (such as a screen), a set of VR goggles, a heads-up display, or another type of display. The XR device may be an AR glasses device, a VR glass device, or other gaming device.

The XR functionalities may be supported by an application server. The application server may host an application, such as a gaming application, a video streaming application, an XR, VR, or AR application, and/or another type of application for which communication flows of streaming data are provided between a UE 120 and the application server, between an XR device and the application server, and/or between the application server and another device in the wireless communication network 100. The application server may be included in an edge server, a cloud environment, and/or another type of server environment. A UE 120 and/or an XR device may execute an application client associated with the application hosted by the application server, such as a gaming application client, a video streaming application client, an XR application client, a VR application client, an AR application client, and/or another type of application client.

In some aspects, the UE 120 may include a communication manager 150. As described in more detail elsewhere herein, the communication manager 150 may receive a configuration message conveying RBR information, wherein the configuration message includes a type indicator that indicates whether the RBR information is to be interpreted as being an enhanced type of RBR information or a non-enhanced type of RBR information; and communicate XR traffic in accordance with a data stream configuration of the RBR information and based on the type indicator indicating the RBR information is to be interpreted as the enhanced type of RBR information. Additionally, or alternatively, the communication manager 150 may perform one or more other operations described herein.

In some aspects, the network node 110 may include a communication manager 155. As described in more detail elsewhere herein, the communication manager 155 may transmit a configuration message conveying RBR information, wherein the configuration message includes a type indicator that indicates whether the RBR information is to be interpreted as being an enhanced type of RBR information or a non-enhanced type of RBR information; and communicate XR traffic in accordance with a data stream configuration of the RBR information and based on the type indicator indicating the RBR information is to be interpreted as the enhanced type of RBR information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

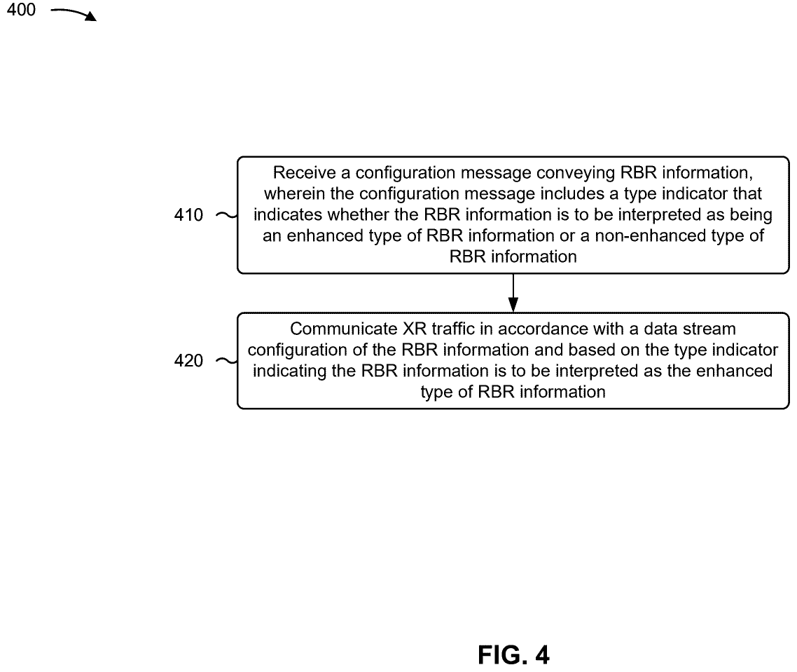

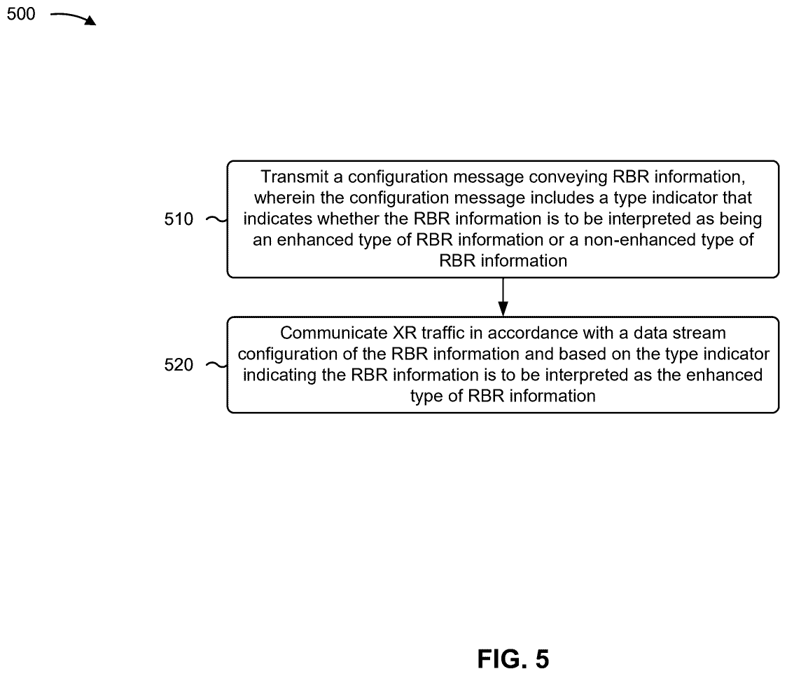

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with data stream control for extended reality communications, as described in more detail elsewhere herein. For example, the processing system 145 of the network node 110, the processing system 140 of the UE 120, the CU 210, the DU 230, or the RU 240 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 400 of FIG. 4, process 500 of FIG. 5, or other processes as described herein. In some examples, executing instructions may include running the instructions, converting the instructions, compiling the instructions, and/or interpreting the instructions, among other examples.

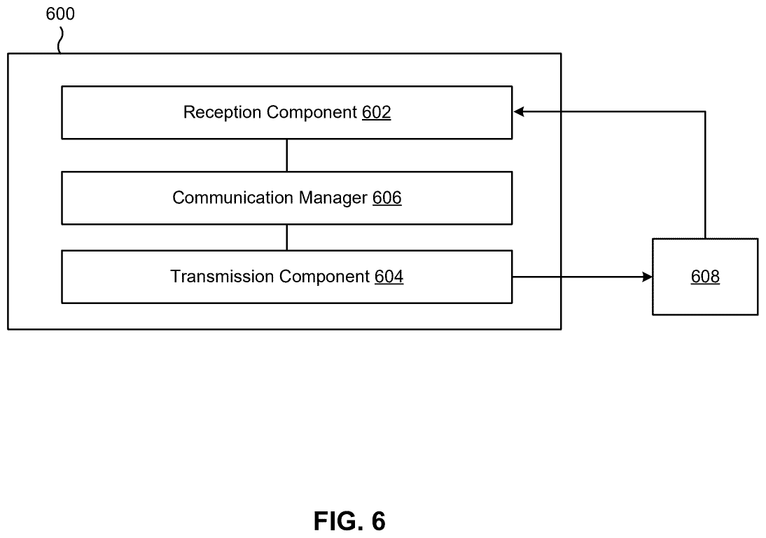

In some aspects, the UE 120 includes means for receiving a configuration message conveying RBR information, wherein the configuration message includes a type indicator that indicates whether the RBR information is to be interpreted as being an enhanced type of RBR information or a non-enhanced type of RBR information; and/or means for communicating XR traffic in accordance with a data stream configuration of the RBR information and based on the type indicator indicating the RBR information is to be interpreted as the enhanced type of RBR information. The means for the UE 120 to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6) and/or a transmission component (for example, transmission component 604 depicted and described in connection with FIG. 6), among other examples.

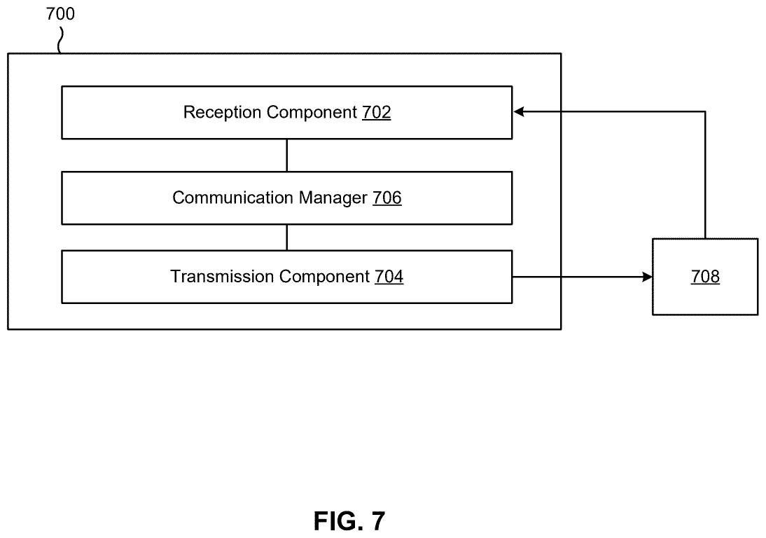

In some aspects, the network node 110 includes means for transmitting a configuration message conveying RBR information, wherein the configuration message includes a type indicator that indicates whether the RBR information is to be interpreted as being an enhanced type of RBR information or a non-enhanced type of RBR information; and/or means for communicating XR traffic in accordance with a data stream configuration of the RBR information and based on the type indicator indicating the RBR information is to be interpreted as the enhanced type of RBR information. The means for the network node to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

A UE may provide XR functionalities (e.g., XR services of XR applications) by providing rendered data via a display. The XR functionalities may be supported by an application server and one or more associated network nodes. The application server may host an server-side application associated with an XR functionality and which may correspond to a client-side application at the UE. In some examples, a network node may transmit data to a UE to render for client-side processing. In some examples, a UE may transmit data to the network node for offloaded processing. In examples with offloaded processing, the UE may offload some data processing to the network node and may processed data from the network node for display. For example, the network node may render some video data and provide the video data to the UE for display. At least partially offloaded processing may reduce a device complexity at the UE and/or a utilization of processing resources relative to client-side processing.

Adaptive rate control (ARC) is a technique to adjust a data rate of a data stream. For example, a UE and/or a network node may adjust a data rate with which multimedia data is being communicated based on a dynamic channel condition of a link between the UE and the network node. ARC can be used to achieve real-time and low latency requirements of some XR services. For example, ARC can be used to enable a network node to provide data to a UE for client-side processing, a UE to provide data to a network node for offloaded processing, or a network node to provide processed data to the UE in connection with offloaded processing, among other examples.

One technique for ARC that is used in some communication deployments is explicit congestion notification (ECN), which is used in low latency, low loss, and scalable (L4S) network services, such as for XR service, and which may be referred to as ECN/L4S network services. An ECN/L4S network service may mark a packet with a congestion experienced (CE) marking codepoint in an Internet Protocol (IP) header when a queue delay satisfies a threshold. As the queue delay increases, a likelihood of a packet being marked with an ECN/L4S marking increases. A transmitting device may use information regarding the ECN/L4S markings to adjust a bitrate (or another data stream parameter).

However, in multi-hop networks, some ECN/L4S markings may be lost (e.g., not returned to an original sending application) and some packets that experience queue delays may not be marked with ECN/L4S markings (e.g., as a result of each hop having less than a threshold queue delay but the plurality of hops having a collective queue delay greater than the threshold). Accordingly, another technique for ARC is the usage of an explicit indication of an RBR. For example, a RAN may provide an RBR indicator (or an indicator of another communication parameter) to a device that is to transmit data (and/or to a device that is to receive data). For example, a UE may transmit a bit rate recommendation query (e.g., with a desired bit rate identifier) to a network node and may receive, as a response, a bit rate recommendation message identifying an RBR value. One type of bit rate field is described in 3GPP Technical Specification (TS) 38.321, Version 18.2.0, Section 6.1.3.20 and Table 6.1.3.20-1, which may be referred to as a “legacy RBR indicator” or a “first type of RBR indicator” and which may be configured for, for example, Voice over LTE (VoLTE) communications, Voice over NR (VoNR) communications, or video calling communications. However, XR traffic may have characteristics for which a recommended a legacy RBR indicator is poorly suited. For example, XR traffic may differ from voice or video calling with respect to bit rate granularity, RBR updating, averaging windows, video sequence patterns, or usage of a maximum bit rate, among other examples.

Various aspects relate generally to data stream control for XR traffic. Some aspects more specifically relate to a type of RBR indicator that is specified for parameters of XR traffic. In some aspects, an XR traffic type of RBR indicator may differ from another (e.g., legacy) type of RBR indicator with respect to one or more parameters, such as a bit rate granularity, an RBR update policy, an averaging window, a video sequence pattern, or support for a maximum bit rate. In some examples, the described techniques may improve network utilization by providing an XR traffic type of RBR indicator. Based on adjusting one or more configurations (e.g., an ARC configuration) based on the XR traffic type of RBR indicator, the described techniques can be used to improve XR service performance, such as by improving throughput, reducing latency, improving reliability, or reducing loss, among other examples. In some aspects, a UE may receive a type indicator that indicates whether an RBR indicator is a legacy type of RBR indicator or an XR type of RBR indicator. In some examples, the described techniques may improve signaling by ensuring that a UE can interpret an RBR indicator as being associated with a correct type (e.g., a type that the network node configures the RBR indicator).

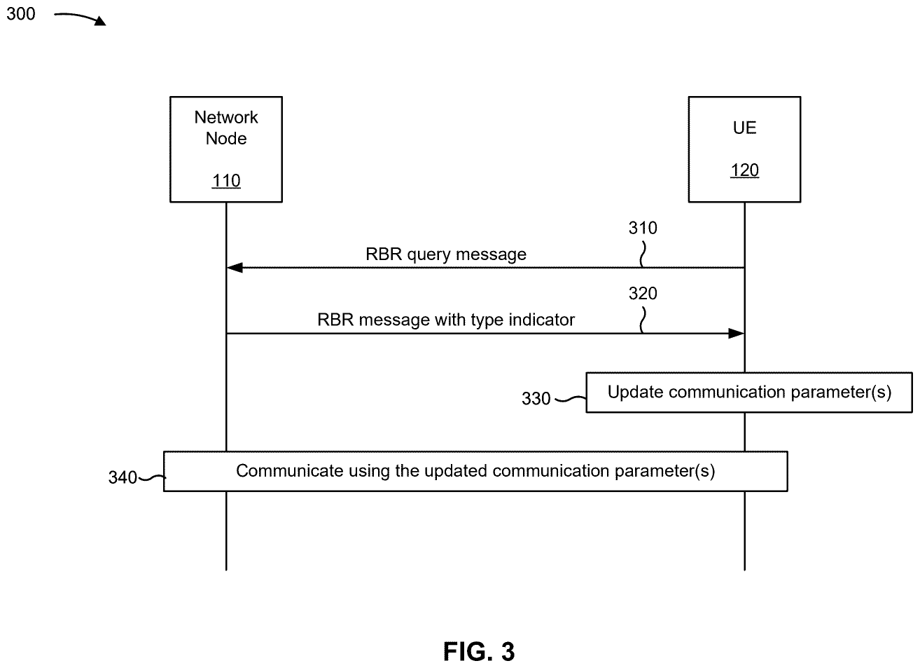

FIG. 3 is a diagram illustrating an example 300 associated with data stream control for XR communications, in accordance with the present disclosure. As shown in FIG. 3, example 300 includes communication between a network node 110 and a UE 120.

As further shown in FIG. 3, and by reference number 310, the UE 120 may transmit an RBR query message to the network node 110. For example, the UE 120 may transmit, and the network node 110 may receive, a message requesting an RBR update. In some aspects, the UE 120 may include, in the RBR query message, a recommendation for the RBR update. For example, the UE 120 may determine a desired bit rate for subsequent XR data stream communication and may include an indicator of the desired bit rate in the RBR query message. In this case, the indicator of the desired bit rate may include information identifying a value of the desired bit rate or information identifying a change to a current bit rate (e.g., to achieve the desired bit rate), among other examples. In some aspects, the UE 120 may transmit the RBR query message in an uplink control message, such as an uplink control information (UCI) message on a physical uplink control channel. Additionally, or alternatively, the UE 120 may include the RBR query message in another type of message, such as in a MAC-CE or information element (IE) of another message.

In some aspects, the network node 110 may configure the UE 120 with an update policy regarding whether the UE 120 is to report a desired bit rate to the network node 110. For example, the network node 110 may configure the UE 120 with a periodicity (e.g., a timer value), a set of events associated with a bit rate (e.g., when a bit rate changes by more than a threshold amount or percentage), a set of events associated with an averaging window (e.g., when an averaging window is to change by more than a threshold amount or percentage), or a set of events relating to data content (e.g., a scene change within video data associated with an XR data stream). In this case, based on satisfaction of a configured event (or a timer elapsing), the UE 120 may transmit a request for a bit rate update via an RBR query message. In some aspects, the network node 110 may configure the UE 120 with the update policy using a particular type of messaging, such as RRC message, UE assistance information (UAI) messaging, RRC reconfiguration messaging, or a MAC-CE command message. In some aspects, the network node 110 may configure the update policy in connection with a protocol data unit (PDU) session setup.

In some aspects, the UE 120 may request an update to an averaging window in connection with an RBR query message. For example, the UE 120 may use an RBR query message to request that the network node 110 reset or update an averaging window. The UE 120 may request averaging window update based on a predicted scene complexity of a new (e.g., upcoming) frame. In other words, when a scene changes from a first scene to a second scene, there may be little or no correlation between bit rates of the first scene and the second scene. Accordingly, the UE 120 may request that the averaging window be updated or reset for the second scene. Additionally, or alternatively, the network node 110 may update or reset the averaging window without having received a UE request. In some aspects, the UE 120 may request (or the network node 110 may determine to) update or reset of the averaging window based on a condition. For example, the averaging window may be update or reset when there is a rapid channel change condition, when there is a multi-user congestion condition, or when an RBR query is transmitted (in other words, when there is an update to an RBR, there may also be an update or reset to the averaging window). In some aspects, the UE 120 may transmit an RBR query message including an indication of a desired maximum bit rate. For example, the UE 120 may request that the maximum bit rate for an averaging window be set at a particular value.

As further shown in FIG. 3, and by reference number 320, the UE 120 may receive an RBR message with a type indicator. For example, the network node 110 may transmit, and the UE 120 may receive, an RBR update message identifying an RBR or another communication parameter for a data stream, such as an XR data stream. In some aspects, the UE 120 may receive the RBR message via a particular type of message. For example, the UE 120 may receive a MAC-CE message (e.g., a MAC-CE command) conveying the RBR message as an information element (IE). Additionally, or alternatively, the UE 120 may receive downlink control information (DCI), radio resource control (RRC) signaling, an information block (e.g., a system information block (SIB) or master information block (MIB)), or another type of control signaling.

In some aspects, the network node 110 may set a type indicator in the RBR message. For example, the network node 110 may include an indicator value in the RBR message indicating whether the RBR message is to be interpreted as including an enhanced type of RBR information (e.g., RBR information configured for an XR data stream) or a non-enhanced type of RBR information (e.g., legacy RBR information, such as RBR information configured for VoLTE, VoNR, or video calling). As one example, when the RBR message is conveyed via a MAC-CE message. As one example of a content of the MAC-CE message, the MAC-CE message may include a logical channel identifier (LCID) value that the UE 120 may interpret as a type indicator (e.g., a first LCID value may correspond to an enhanced type of RBR information and a second LCID value may correspond to a non-enhanced type of RBR information). Additionally, or alternatively, the RBR message (e.g., conveyed via a MAC-CE) may include a data radio bearer (DRB) identifier or a quality of service (QoS) flow identifier (QFI). The UE 120 may interpret the RBR message (e.g., conveyed via a MAC-CE) as indicating whether an RBR message includes enhanced RBR information. For example, the UE 120 may request that an upper layer application, such as an RRC application or a non-access stratum (NAS) application check whether a QoS flow identifier or DRB identifier corresponds to an XR data stream and may interpret the correspondence as indicating whether enhanced RBR information is included in an RBR message. In some aspects, a MAC-CE may have a MAC-CE identifier (MAC-CE ID) that includes one or more reserved bits indicating enhanced RBR information. Additionally, or alternatively, a legacy RBR message may include a reserved bit field that the network node 110 may set with a bit indicator to indicate whether to re-interpret the legacy RBR message as a non-legacy RBR message (e.g., that conveys enhanced RBR information).

Additionally, or alternatively, the network node 110 may configure a particular format for the RBR message and the UE 120 may determine whether the RBR message is to be interpreted as including an enhanced type of RBR information or a non-enhanced type of RBR information based on the particular format. As one example, a legacy type of RBR message may have a set of reserved bits that, when set to values, indicate that the set of values of the set of reserved bits convey enhanced RBR information. In this case, the particular format (or usage of reserved bits) may serve as a type indicator for the RBR message. Additionally, or alternatively, the network node 110 may transmit the RBR message in a particular set of resources, and the UE 120 may determine whether the RBR message is to be interpreted as including an enhanced type of RBR information or a non-enhanced type of RBR information based on the particular set of resources. Additionally, or alternatively, the UE 120 may interpret whether the RBR message includes the enhanced type of RBR information or the non-enhanced type of RBR information based on whether XR data is being communicated, a status of an XR application, or another factor.

As further shown in FIG. 3, and by reference number 330, the UE 120 may update one or more communication parameters. For example, the UE 120 may update a bit rate for an XR data stream based on the RBR message identifying the RBR for the XR data stream. In some aspects, the UE 120 may update a bit rate with a bit rate granularity associated with enhanced RBR information. For example, non-enhanced RBR information may include a bit rate multiplier configurable as a first set of multipliers (e.g., ‘40,’ ‘70,’ ‘100,’ or ‘200’) and enhanced RBR information may include a bit rate multiplier configurable as a second set of multipliers (e.g., ‘5,’ ‘10,’ ‘15,’ or ‘20’), which may provide a greater degree of granularity relative to the first set of multipliers. Accordingly, based on interpreting the RBR message including enhanced RBR information, the UE 120 may select a bit rate using the second set of multipliers.

In some aspects, the UE 120 may update a bit rate with a bit rate step size or maximum bit rate associated with enhanced RBR information. For example, non-enhanced RBR information may be associated with a first step size and enhanced RBR information may be associated with a second step size for incrementing a recommended bit rate relative to index values of a table (e.g., a table specified for XR traffic). In other words, and as an example, the UE 120 may use a dedicated XR traffic table that is configured for the UE 120 or the UE 120 may adapt a non-dedicated XR traffic table by using the second step size, which may cause the UE 120 to construct a dedicated XR traffic table from the non-dedicated XR traffic table. Accordingly, based on interpreting the RBR message including enhanced RBR information, the UE 120 may select a bit rate using the second step size. In other words, for a given index value, the first step size may correspond to a first bit rate and the second step size may correspond to a second bit rate and the UE 120 may select the second bit rate when interpreting enhanced RBR information. Additionally, or alternatively, the UE 120 may use a maximum bit rate size that is associated with enhanced RBR information. In other words, non-enhanced RBR information may have a first maximum bit rate and enhanced RBR information may have a second maximum bit rate.

In some aspects, the UE 120 may update a bit rate with a particular type of index mapping step pattern. For example, non-enhanced RBR information is associated with an irregular step size, such that a step size of 2 is used for index values 0 to 6, a step size of 4 is used for index values 7 to 8, a step size of 3 is used for index values 8 to 9, a step size of 4 is used for index values 9 to 11, a step size of 8 is used for index values 11 to 13, a step size of 6 is used for index values 13 to 14, among other examples. For enhanced RBR information, a regular, ordered step size may be used, such as step sizes of 2, 4, 6, 8, . . . , 100, 250, and 500 for incrementing recommended bit rates for each sequential index value.

In some aspects, the UE 120 may determine a value for the bit rate multiplier based on a content of the RBR message. For example, non-enhanced RBR information may have a fixed set of bit rate multipliers that may be used, or not used, based on a parameter value (e.g., indicating whether use of the bit rate multiplier is on or off). In contrast, the enhanced RBR information may have a dynamic bit rate multiplier that can be specified as a field of the RBR message. In this case, based on a value in the field of the RBR message, the UE 120 may select a bit rate multiplier to apply to a bit rate value and determine a bit rate. In some aspects, the UE 120 may determine the bit rate based on a multi-stage indication. For example, the UE 120 may receive a first indication of a first, coarse granularity bit rate selection and a second indication of a second, fine granularity bit rate selection (e.g., a first indication of a coarse bit rate and a second indication of an offset from the coarse bit rate to select a fine bit rate that is used as the bit rate). In this case, the network node 110 may convey the multi-stage indication in a single RBR message or in a plurality of RBR messages.

In some aspects, the UE 120 update the bit rate based on an RBR update policy indication. For example, the network node 110 may configure the UE 120 to update an RBR based on (e.g., as a response to or based on a prediction of) satisfaction of a condition. The condition may relate to a channel change within a threshold period of time (e.g., a rapid channel change scenario) or a multi-user congestion scenario. In this case, the UE 120 may use the RBR and an averaging window indicated by the network node, as described herein.

In some aspects, the UE 120 may receive information identifying a set of bit rates and may select a bit rate from the set of bit rates in accordance with a video sequence pattern. For example, the network node 110 may provide information identifying a set of bit rates corresponding to a video encoding sequence (e.g., an I frame (I), P₁ frame (P₁), P₂ frame (P₂), P₃ frame (P₃) (IP₁P₂P₃) sequence or an I frame, P frame (IP) sequence). In this case, the UE 120 may use the set of bit rates to select a bit rate for each frame of the video encoding sequence (based on a type of each frame, such as I or P) and may repeat usage of each bit rate as the video encoding sequence repeats (or as usage of the type of frame repeats). In some aspects, the UE 120 may receive, from the network node 110, an indication of which frame (e.g., which PDU set or PDU set sequence number (SN)) is associated with a first bit rate in a set of bit rates. In this case, the UE 120 may apply the first bit rate to the indicated frame and subsequent bit rates to subsequent frames.

In some aspects, the UE 120 may determine an averaging window based on the RBR message. For example, the UE 120 may indicate a desired averaging window (e.g., for uplink or downlink) to the network node 110 in the RBR query message and may receive an RBR message conveying enhanced RBR information with an indication of a selected averaging window. In this case, the network node 110 may indicate the uplink or downlink averaging window that is selected based on the desired averaging window, a current channel condition (e.g., an amount by which a channel metric is varying over time), or a predicted channel condition (e.g., an amount by which a channel metric is expected to vary over time). In some aspects, an indicator of the averaging window may indicate the averaging window on a time basis (e.g., a quantity of milliseconds), a frame basis (e.g., a quantity of video frames or an integer multiple of a frame periodicity), or another basis. In some aspects, the UE 120 may receive the RBR message conveying the averaging window via a MAC-CE, RRC signaling, UAI signaling, RRC reconfiguration signaling, or PDU session setup signaling. For example, the network node 110 may configure a bit indicator (e.g., an IE of an RBR message with enhanced RBR information) that indicates that the UE 120 is to reset an averaging window. Based on receiving the RBR message, the UE 120 may reset the averaging window, accordingly. Additionally, or alternatively, the UE 120 may receive DCI or RRC signaling with an indication to update or reset an averaging window. In some aspects, the UE 120 may use a statically specified averaging window for a data stream (e.g., an XR data stream), such as an averaging window specified in a specification. In some aspects, the UE 120 may configure a maximum bit rate for the averaging window. For example, the UE 120 may receive, from the network node 110, an indication of a maximum bit rate that the UE 120 is to use (e.g., that the XR data stream is not to exceed in any frame). Additionally, or alternatively, the UE 120 may receive, from the network node 110, an indication of a bit rate variance or a minimum bit rate that the UE 120 is to use for an averaging window.

As further shown in FIG. 3, and by reference number 340, the UE 120 and the network node 110 may communicate using one or more updated communication parameters. For example, based on the UE 120 updating a bit rate, the UE 120 may transmit, and the network node 110 may receive, an XR data stream with the updated bit rate. Additionally, or alternatively, the network node 110 may transmit an XR data stream to the UE 120.

As indicated above, FIG. 3 is provided as an example. Other examples may differ from what is described with respect to FIG. 3.

FIG. 4 is a diagram illustrating an example process 400 performed, for example, at a UE or an apparatus of a UE, in accordance with the present disclosure. Example process 400 is an example where the apparatus or the UE (e.g., UE 120) performs operations associated with data stream control for extended reality communications.

As shown in FIG. 4, in some aspects, process 400 may include receiving a configuration message conveying RBR information, wherein the configuration message includes a type indicator that indicates whether the RBR information is to be interpreted as being an enhanced type of RBR information or a non-enhanced type of RBR information (block 410). For example, the UE (e.g., using reception component 602 and/or communication manager 606, depicted in FIG. 6) may receive a configuration message conveying RBR information, wherein the configuration message includes a type indicator that indicates whether the RBR information is to be interpreted as being an enhanced type of RBR information or a non-enhanced type of RBR information, as described above.

As further shown in FIG. 4, in some aspects, process 400 may include communicating XR traffic in accordance with a data stream configuration of the RBR information and based on the type indicator indicating the RBR information is to be interpreted as the enhanced type of RBR information (block 420). For example, the UE (e.g., using reception component 602, transmission component 604, and/or communication manager 606, depicted in FIG. 6) may communicate XR traffic in accordance with a data stream configuration of the RBR information and based on the type indicator indicating the RBR information is to be interpreted as the enhanced type of RBR information, as described above.

Process 400 may include additional aspects, such as any single aspect or any combination of aspects described below and/or in connection with one or more other processes described elsewhere herein.

In a first aspect, the type indicator is included in a set of reserved bits of a MAC-CE conveying the configuration message, and wherein the MAC-CE is associated with a format for conveying both the enhanced type of RBR information and the non-enhanced type of RBR information.

In a second aspect, alone or in combination with the first aspect, the type indicator is an implicit indication based on inclusion of one or more parameters, associated with the enhanced type of RBR information, in a reserved field of a message associated with conveying the non-enhanced type of RBR information.

In a third aspect, alone or in combination with one or more of the first and second aspects, the type indicator is included in a MAC-CE identifier of a MAC-CE conveying the configuration message, and wherein the MAC-CE is a dedicated format for the enhanced type of RBR information.

In a fourth aspect, alone or in combination with one or more of the first through third aspects, the configuration message is conveyed in at least one of a MAC-CE, a radio resource control message, a downlink control information message, or an information block message.

In a fifth aspect, alone or in combination with one or more of the first through fourth aspects, the enhanced type of RBR information is associated with a first type for a parameter and the non-enhanced type of RBR information are associated with a second type for the parameter, wherein the parameter includes at least one of a bit rate granularity parameter, a bit rate step parameter, a maximum bit rate parameter, a bit rate index mapping parameter, a bit rate multiplier parameter, or a bit rate indication multiple stage parameter.

In a sixth aspect, alone or in combination with one or more of the first through fifth aspects, process 400 includes receiving a network node initiated RBR information update message, and communicating the XR traffic in accordance with an updated data stream configuration associated with the network node initiated RBR information update message.

In a seventh aspect, alone or in combination with one or more of the first through sixth aspects, process 400 includes transmitting, before expiration of a prohibit timer associated with the RBR information, a UE-initiated RBR information update query message, and communicating the XR traffic in accordance with an updated data stream configuration associated with a response to the UE-initiated RBR information update query message.

In an eighth aspect, alone or in combination with one or more of the first through seventh aspects, the UE-initiated RBR information update message is triggered based on at least one of a periodicity, a bit rate event, an averaging window event, a content event.

In a ninth aspect, alone or in combination with one or more of the first through eighth aspects, process 400 includes transmitting a request message identifying a requested averaging window for the RBR information, receiving, as a response to the request message, a response message configuring a selected averaging window for the RBR information, and wherein communicating the XR traffic comprises communicating the XR traffic in accordance with the selected averaging window.

In a tenth aspect, alone or in combination with one or more of the first through ninth aspects, process 400 includes resetting the selected averaging window based on at least one of an occurrence of an event, or a received instruction.

In an eleventh aspect, alone or in combination with one or more of the first through tenth aspects, process 400 includes receiving another configuration message with updated RBR information with an information element associated with conveying a parameter to trigger resetting the selected averaging window.

In a twelfth aspect, alone or in combination with one or more of the first through eleventh aspects, the RBR information includes pattern information identifying a set of possible bit rates corresponding to a set of frame types, and wherein communicating the XR traffic comprises communicating the XR traffic in accordance with the pattern information.

In a thirteenth aspect, alone or in combination with one or more of the first through twelfth aspects, the RBR information includes an indicator of at least one of a maximum bit rate, a minimum bit rate, or a variance of bit rate.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node, in accordance with the present disclosure. Example process 500 is an example where the apparatus or the network node (e.g., network node 110) performs operations associated with data stream control for extended reality communications.

As shown in FIG. 5, in some aspects, process 500 may include transmitting a configuration message conveying recommended bit rate (RBR) information, wherein the configuration message includes a type indicator that indicates whether the RBR information is to be interpreted as being an enhanced type of RBR information or a non-enhanced type of RBR information (block 510). For example, the network node (e.g., using transmission component 704 and/or communication manager 706, depicted in FIG. 7) may transmit a configuration message conveying RBR information, wherein the configuration message includes a type indicator that indicates whether the RBR information is to be interpreted as being an enhanced type of RBR information or a non-enhanced type of RBR information, as described above.

As further shown in FIG. 5, in some aspects, process 500 may include communicating XR traffic in accordance with a data stream configuration of the RBR information and based on the type indicator indicating the RBR information is to be interpreted as the enhanced type of RBR information (block 520). For example, the network node (e.g., using reception component 702, transmission component 704, and/or communication manager 706, depicted in FIG. 7) may communicate XR traffic in accordance with a data stream configuration of the RBR information and based on the type indicator indicating the RBR information is to be interpreted as the enhanced type of RBR information, as described above.

Process 500 may include additional aspects, such as any single aspect or any combination of aspects described below and/or in connection with one or more other processes described elsewhere herein.

In a first aspect, the type indicator is included in a set of reserved bits of a MAC-CE conveying the configuration message, and wherein the MAC-CE is associated with a format for conveying both the enhanced type of RBR information and the non-enhanced type of RBR information.

In a second aspect, alone or in combination with the first aspect, the type indicator is an implicit indication based on inclusion of one or more parameters, associated with the enhanced type of RBR information, in a reserved field of a message associated with conveying the non-enhanced type of RBR information.

In a third aspect, alone or in combination with one or more of the first and second aspects, the type indicator is included in a MAC-CE identifier of a MAC-CE conveying the configuration message, and wherein the MAC-CE is a dedicated format for the enhanced type of RBR information.

In a fourth aspect, alone or in combination with one or more of the first through third aspects, the configuration message is conveyed in at least one of a MAC-CE, an RRC message, a DCI message, or an information block message.

In a fifth aspect, alone or in combination with one or more of the first through fourth aspects, the enhanced type of RBR information is associated with a first type for a parameter and the non-enhanced type of RBR information are associated with a second type for the parameter, wherein the parameter includes at least one of a bit rate granularity parameter, a bit rate step parameter, a maximum bit rate parameter, a bit rate index mapping parameter, a bit rate multiplier parameter, or a bit rate indication multiple stage parameter.

In a sixth aspect, alone or in combination with one or more of the first through fifth aspects, process 500 includes transmitting a network node initiated RBR information update message, and communicating the XR traffic in accordance with an updated data stream configuration associated with the network node initiated RBR information update message.

In a seventh aspect, alone or in combination with one or more of the first through sixth aspects, process 500 includes receiving, before expiration of a prohibit timer associated with the RBR information, a UE-initiated RBR information update query message, transmitting the configuration message based on receiving the UE-initiated RBR information update query message.

In an eighth aspect, alone or in combination with one or more of the first through seventh aspects, the UE-initiated RBR information update message is triggered based on at least one of a periodicity, a bit rate event, an averaging window event, a content event.

In a ninth aspect, alone or in combination with one or more of the first through eighth aspects, process 500 includes receiving a request message identifying a requested averaging window for the RBR information, transmitting, as a response to the request message, a response message configuring a selected averaging window for the RBR information, and wherein communicating the XR traffic comprises communicating the XR traffic in accordance with the selected averaging window.

In a tenth aspect, alone or in combination with one or more of the first through ninth aspects, the RBR information includes pattern information identifying a set of possible bit rates corresponding to a set of frame types, and wherein communicating the XR traffic comprises communicating the XR traffic in accordance with the pattern information.

In an eleventh aspect, alone or in combination with one or more of the first through tenth aspects, the RBR information includes an indicator of at least one of a maximum bit rate, a minimum bit rate, or a variance of bit rate.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602, a transmission component 604, and/or a communication manager 606, which may be in communication with one another (for example, via one or more buses and/or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4. In some aspects, the apparatus 600 and/or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 and/or the transmission component 604. For example, the communication manager 606 may receive information associated with configuring reception of communications by the reception component 602 and/or transmission of communications by the transmission component 604. Additionally, or alternatively, the communication manager 606 may generate and/or provide control information to the reception component 602 and/or the transmission component 604 to control reception and/or transmission of communications.

The reception component 602 may receive a configuration message conveying RBR information, wherein the configuration message includes a type indicator that indicates whether the RBR information is to be interpreted as being an enhanced type of RBR information or a non-enhanced type of RBR information. The reception component 602 and/or the transmission component 604 may communicate XR traffic in accordance with a data stream configuration of the RBR information and based on the type indicator indicating the RBR information is to be interpreted as the enhanced type of RBR information.

The reception component 602 may receive a network node initiated RBR information update message. The communication manager 606 may communicate the XR traffic in accordance with an updated data stream configuration associated with the network node initiated RBR information update message. The transmission component 604 may transmit, before expiration of a prohibit timer associated with the RBR information, a UE-initiated RBR information update query message.

The communication manager 606 may communicate the XR traffic in accordance with an updated data stream configuration associated with a response to the UE-initiated RBR information update query message. The transmission component 604 may transmit a request message identifying a requested averaging window for the RBR information. The reception component 602 may receive, as a response to the request message, a response message configuring a selected averaging window for the RBR information. The communication manager 606 may reset the selected averaging window based on at least one of: an occurrence of an event, or a received instruction. The reception component 602 may receive another configuration message with updated RBR information with an information element associated with conveying a parameter to trigger resetting the selected averaging window.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication, in accordance with the present disclosure. The apparatus 700 may be a network node, or a network node may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5. In some aspects, the apparatus 700 and/or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 and/or the transmission component 704 may include or may be included in a network interface. The network interface may be configured to obtain and/or output signals for the apparatus 700 via one or more communications links, such as a backhaul link, a midhaul link, and/or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The transmission component 704 may transmit a configuration message conveying RBR information, wherein the configuration message includes a type indicator that indicates whether the RBR information is to be interpreted as being an enhanced type of RBR information or a non-enhanced type of RBR information. The reception component 702 and/or the transmission component 704 may communicate XR traffic in accordance with a data stream configuration of the RBR information and based on the type indicator indicating the RBR information is to be interpreted as the enhanced type of RBR information.

The transmission component 704 may transmit a network node initiated RBR information update message. The communication manager 706 may communicate the XR traffic in accordance with an updated data stream configuration associated with the network node initiated RBR information update message. The reception component 702 may receive, before expiration of a prohibit timer associated with the RBR information, a UE-initiated RBR information update query message.

The transmission component 704 may transmit the configuration message based on receiving the UE-initiated RBR information update query message. The reception component 702 may receive a request message identifying a requested averaging window for the RBR information. The transmission component 704 may transmit, as a response to the request message, a response message configuring a selected averaging window for the RBR information.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: receiving a configuration message conveying recommended bit rate (RBR) information, wherein the configuration message includes a type indicator that indicates whether the RBR information is to be interpreted as being an enhanced type of RBR information or a non-enhanced type of RBR information; and communicating extended reality (XR) traffic in accordance with a data stream configuration of the RBR information and based on the type indicator indicating the RBR information is to be interpreted as the enhanced type of RBR information.

Aspect 2: The method of Aspect 1, wherein the type indicator is included in a set of reserved bits of a medium access control (MAC) control element (CE) conveying the configuration message, and wherein the MAC-CE is associated with a format for conveying both the enhanced type of RBR information and the non-enhanced type of RBR information.

Aspect 3: The method of any of Aspects 1-2, wherein the type indicator is an implicit indication based on inclusion of one or more parameters, associated with the enhanced type of RBR information, in a reserved field of a message associated with conveying the non-enhanced type of RBR information.

Aspect 4: The method of any of Aspects 1-3, wherein the type indicator is included in a medium access control (MAC) control element (CE) identifier of a MAC-CE conveying the configuration message, and wherein the MAC-CE is a dedicated format for the enhanced type of RBR information.

Aspect 5: The method of any of Aspects 1-4, wherein the configuration message is conveyed in at least one of: a medium access control (MAC) control element, a radio resource control message, a downlink control information message, or an information block message.

Aspect 6: The method of any of Aspects 1-5, wherein the enhanced type of RBR information is associated with a first type for a parameter and the non-enhanced type of RBR information are associated with a second type for the parameter, wherein the parameter includes at least one of: a bit rate granularity parameter, a bit rate step parameter, a maximum bit rate parameter, a bit rate index mapping parameter, a bit rate multiplier parameter, or a bit rate indication multiple stage parameter.

Aspect 7: The method of any of Aspects 1-6, further comprising: receiving a network node initiated RBR information update message; and communicating the XR traffic in accordance with an updated data stream configuration associated with the network node initiated RBR information update message.

Aspect 8: The method of any of Aspects 1-7, further comprising: transmitting, before expiration of a prohibit timer associated with the RBR information, a UE-initiated RBR information update query message; and communicating the XR traffic in accordance with an updated data stream configuration associated with a response to the UE-initiated RBR information update query message.

Aspect 9: The method of Aspect 8, wherein the UE-initiated RBR information update message is triggered based on at least one of: a periodicity, a bit rate event, an averaging window event, a content event.

Aspect 10: The method of any of Aspects 1-9, further comprising: transmitting a request message identifying a requested averaging window for the RBR information; receiving, as a response to the request message, a response message configuring a selected averaging window for the RBR information; and wherein communicating the XR traffic comprises: communicating the XR traffic in accordance with the selected averaging window. wherein communicating the XR traffic comprises: communicating the XR traffic in accordance with the selected averaging window.

Aspect 11: The method of Aspect 10, further comprising: resetting the selected averaging window based on at least one of: an occurrence of an event, or a received instruction.

Aspect 12: The method of Aspect 11, further comprising: receiving another configuration message with updated RBR information with an information element associated with conveying a parameter to trigger resetting the selected averaging window.

Aspect 13: The method of any of Aspects 1-12, wherein the RBR information includes pattern information identifying a set of possible bit rates corresponding to a set of frame types; and wherein communicating the XR traffic comprises: communicating the XR traffic in accordance with the pattern information.

Aspect 14: The method of any of Aspects 1-13, wherein the RBR information includes an indicator of at least one of: a maximum bit rate, a minimum bit rate, or a variance of bit rate.

Aspect 15: A method of wireless communication performed by a network node, comprising: transmitting a configuration message conveying recommended bit rate (RBR) information, wherein the configuration message includes a type indicator that indicates whether the RBR information is to be interpreted as being an enhanced type of RBR information or a non-enhanced type of RBR information; and communicating extended reality (XR) traffic in accordance with a data stream configuration of the RBR information and based on the type indicator indicating the RBR information is to be interpreted as the enhanced type of RBR information.

Aspect 16: The method of Aspect 15, wherein the type indicator is included in a set of reserved bits of a medium access control (MAC) control element (CE) conveying the configuration message, and wherein the MAC-CE is associated with a format for conveying both the enhanced type of RBR information and the non-enhanced type of RBR information.

Aspect 17: The method of any of Aspects 15-16, wherein the type indicator is an implicit indication based on inclusion of one or more parameters, associated with the enhanced type of RBR information, in a reserved field of a message associated with conveying the non-enhanced type of RBR information.

Aspect 18: The method of any of Aspects 15-17, wherein the type indicator is included in a medium access control (MAC) control element (CE) identifier of a MAC-CE conveying the configuration message, and wherein the MAC-CE is a dedicated format for the enhanced type of RBR information.

Aspect 19: The method of any of Aspects 15-18, wherein the configuration message is conveyed in at least one of: a medium access control (MAC) control element, a radio resource control message, a downlink control information message, or an information block message.

Aspect 20: The method of any of Aspects 15-19, wherein the enhanced type of RBR information is associated with a first type for a parameter and the non-enhanced type of RBR information are associated with a second type for the parameter, wherein the parameter includes at least one of: a bit rate granularity parameter, a bit rate step parameter, a maximum bit rate parameter, a bit rate index mapping parameter, a bit rate multiplier parameter, or a bit rate indication multiple stage parameter.

Aspect 21: The method of any of Aspects 15-20, further comprising: transmitting a network node initiated RBR information update message; and communicating the XR traffic in accordance with an updated data stream configuration associated with the network node initiated RBR information update message.

Aspect 22: The method of any of Aspects 15-21, further comprising: receiving, before expiration of a prohibit timer associated with the RBR information, a UE-initiated RBR information update query message; transmitting the configuration message based on receiving the UE-initiated RBR information update query message.

Aspect 23: The method of Aspect 22, wherein the UE-initiated RBR information update message is triggered based on at least one of: a periodicity, a bit rate event, an averaging window event, a content event.

Aspect 24: The method of any of Aspects 15-23, further comprising: receiving a request message identifying a requested averaging window for the RBR information; transmitting, as a response to the request message, a response message configuring a selected averaging window for the RBR information; and wherein communicating the XR traffic comprises: communicating the XR traffic in accordance with the selected averaging window. wherein communicating the XR traffic comprises: communicating the XR traffic in accordance with the selected averaging window.

Aspect 25: The method of any of Aspects 15-24, wherein the RBR information includes pattern information identifying a set of possible bit rates corresponding to a set of frame types; and wherein communicating the XR traffic comprises: communicating the XR traffic in accordance with the pattern information.

Aspect 26: The method of any of Aspects 15-25, wherein the RBR information includes an indicator of at least one of: a maximum bit rate, a minimum bit rate, or a variance of bit rate.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication, comprising:
one or more memories; and
one or more processors coupled to the one or more memories, the one or more processors individually or collectively configured to:
receive a configuration message conveying recommended bit rate (RBR) information, wherein the configuration message includes a type indicator that indicates whether the RBR information is to be interpreted as being an enhanced type of RBR information or a non-enhanced type of RBR information; and
communicate extended reality (XR) traffic in accordance with a data stream configuration of the RBR information and based on the type indicator indicating the RBR information is to be interpreted as the enhanced type of RBR information.

2. The apparatus of claim 1, wherein the type indicator is included in a set of reserved bits of a medium access control (MAC) control element (MAC-CE) conveying the configuration message, and wherein the MAC-CE is associated with a format for conveying both the enhanced type of RBR information and the non-enhanced type of RBR information.

3. The apparatus of claim 1, wherein the type indicator is an implicit indication based on inclusion of one or more parameters, associated with the enhanced type of RBR information, in a reserved field of a message associated with conveying the non-enhanced type of RBR information.

4. The apparatus of claim 1, wherein the type indicator is included in a medium access control (MAC) control element (MAC-CE) identifier of a MAC-CE conveying the configuration message, and wherein the MAC-CE is a dedicated format for the enhanced type of RBR information.

5. The apparatus of claim 1, wherein the configuration message is conveyed in at least one of:
a medium access control (MAC) control element,
a radio resource control message,
a downlink control information message, or
an information block message.

6. The apparatus of claim 1, wherein the enhanced type of RBR information is associated with a first type for a parameter and the non-enhanced type of RBR information are associated with a second type for the parameter, wherein the parameter includes at least one of:
a bit rate granularity parameter,
a bit rate step parameter,
a maximum bit rate parameter,
a bit rate index mapping parameter,
a bit rate multiplier parameter, or
a bit rate indication multiple stage parameter.

7. The apparatus of claim 1, wherein the one or more processors are further configured to cause the apparatus to:
receive a network node initiated RBR information update message; and
communicate the XR traffic in accordance with an updated data stream configuration associated with the network node initiated RBR information update message.

8. The apparatus of claim 1, wherein the one or more processors are further configured to cause the apparatus to:
transmit, before expiration of a prohibit timer associated with the RBR information, a user equipment (UE)-initiated RBR information update query message; and
communicate the XR traffic in accordance with an updated data stream configuration associated with a response to the UE-initiated RBR information update query message.

9. The apparatus of claim 8, wherein the UE-initiated RBR information update message is triggered based on at least one of:
a periodicity,
a bit rate event,
an averaging window event,
a content event.

10. The apparatus of claim 1, wherein the one or more processors are further configured to cause the apparatus to:
transmit a request message identifying a requested averaging window for the RBR information;
receive, as a response to the request message, a response message configuring a selected averaging window for the RBR information; and
wherein the one or more processors, to cause the apparatus to communicate the XR traffic, are configured to cause the apparatus to:
communicate the XR traffic in accordance with the selected averaging window.

11. The apparatus of claim 10, wherein the one or more processors are further configured to cause the apparatus to:
reset the selected averaging window based on at least one of: an occurrence of an event, or a received instruction.

12. The apparatus of claim 11, wherein the one or more processors are further configured to cause the apparatus to:
receive another configuration message with updated RBR information with an information element associated with conveying a parameter to trigger resetting the selected averaging window.

13. The apparatus of claim 1, wherein the RBR information includes pattern information identifying a set of possible bit rates corresponding to a set of frame types; and
wherein the one or more processors, to cause the apparatus to communicate the XR traffic, are configured to cause the apparatus to:
communicate the XR traffic in accordance with the pattern information.

14. The apparatus of claim 1, wherein the RBR information includes an indicator of at least one of:
a maximum bit rate,
a minimum bit rate, or
a variance of bit rate.

15. An apparatus for wireless communication, comprising:
one or more memories; and
one or more processors coupled to the one or more memories, the one or more processors individually or collectively configured to:
transmit a configuration message conveying recommended bit rate (RBR) information, wherein the configuration message includes a type indicator that indicates whether the RBR information is to be interpreted as being an enhanced type of RBR information or a non-enhanced type of RBR information; and
communicate extended reality (XR) traffic in accordance with a data stream configuration of the RBR information and based on the type indicator indicating the RBR information is to be interpreted as the enhanced type of RBR information.

16. The apparatus of claim 15, wherein the type indicator is included in a set of reserved bits of a medium access control (MAC) control element (MAC-CE) conveying the configuration message, and wherein the MAC-CE is associated with a format for conveying both the enhanced type of RBR information and the non-enhanced type of RBR information.

17. The apparatus of claim 15, wherein the type indicator is an implicit indication based on inclusion of one or more parameters, associated with the enhanced type of RBR information, in a reserved field of a message associated with conveying the non-enhanced type of RBR information.

18. The apparatus of claim 15, wherein the type indicator is included in a medium access control (MAC) control element (MAC-CE) identifier of a MAC-CE conveying the configuration message, and wherein the MAC-CE is a dedicated format for the enhanced type of RBR information.

19. The apparatus of claim 15, wherein the configuration message is conveyed in at least one of:
a medium access control (MAC) control element,
a radio resource control message,
a downlink control information message, or
an information block message.

20. A method of wireless communication performed by a user equipment (UE), comprising:
receiving a configuration message conveying recommended bit rate (RBR) information, wherein the configuration message includes a type indicator that indicates whether the RBR information is to be interpreted as being an enhanced type of RBR information or a non-enhanced type of RBR information; and
communicating extended reality (XR) traffic in accordance with a data stream configuration of the RBR information and based on the type indicator indicating the RBR information is to be interpreted as the enhanced type of RBR information.
